(19) United States
(12) Patent Application Publication
(10) Pub. No.: US 2010/0237789 A1
(43) Pub. Date: Sep. 23, 2010

(54) LIGHT-EMITTING DIODE (LED) LAMP STRING DEVICE WITH BATTERY BOX

(76) Inventor: XUE-JING FENG, GUANGDONG PROVINCE (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/706,928

(22) Filed: Feb. 17, 2010

(30) Foreign Application Priority Data
Mar. 21, 2009 (CN) 200920053382.9

(51) Int. Cl. H05B 37/02

(52) U.S. Cl. 315/192; 315/185 R

(57) ABSTRACT

A lighting-emitting diode (LED) lamp string device with a battery box is provided. The LED lamp string device includes a power supply system and a lamp string light emission system connected together. The lamp string light emission system includes an LED lamp string that is composed of a plurality of LED lamps and electrical wires that electrically connect the LED lamps. The power supply system includes batteries and a light controller that are connected to the LED lamp string through the electrical wires and further includes a battery box, in which the light controller and the batteries are received.

### FIELD OF THE INVENTION

The present invention relates to a light-emitting diode (LED) lamp string device, and in particular to an LED lamp string device with battery box.

### BACKGROUND OF THE INVENTION

Light-emitting diode (LED) lamp strings are commonly used today and various types of LED lamp string, which are operated with different types of power sources, including alternate current (AC) or direct current (DC), are available in the market. For all types of LED lamp string, they are powered by alternate current. The alternate current is received by the LED lamp string through plugging with an external power source and the alternate current can be directly supplied to the LED lamp string or it is fed through an electrical adaptor to be converted into direct current. To use an LED lamp string outdoors, a power cable connected to an indoor power source must be arranged. This makes it unsafe and inconvenient in switching between different sites. Further, the ON/OFF status of the LED lamp string, the operation time period, regulation of lighting brightness, and switching between different modes/patterns of light twinkling are all controlled in a manual manner. This makes the use of the LED lamp string troublesome and impractical.

### SUMMARY OF THE INVENTION

An objective of the present invention is to provide a light-emitting diode (LED) lamp string device with battery box that uses direct current and is controlled by a light controller.

To realize the objective, the present invention provides an LED lamp string device, which comprises a power supply system and a lamp string light emission system connected together. The lamp string light emission system comprises an LED lamp string that is composed of a plurality of LED lamps and electrical wires that electrically connect the LED lamps. The power supply system comprises batteries and a light controller that are connected to the LED lamp string through the electrical wires and further comprises a battery box, in which the light controller and the batteries are received.

The present invention further provides an LED lamp string device that comprises a battery box. The battery box comprises a box body and a box cover, and further comprises a sealing ring that is mounted to one of the box body and the box cover for providing tight engagement between the box body and the box cover.

The present invention further provides an LED lamp string device, wherein some of the LED lamps are provided with a function of twinkling that is controlled by a light controller. Or alternatively, the LED lamps are all provided with a function of twinkling that is controlled by a light controller.

The present invention further provides an LED lamp string device, wherein the light controller comprises a control circuit, which realizes various lighting patterns through controlling ON/OFF status of the twinkling function of the LED lamps. Or alternatively, wherein the control circuit of the light controller comprises a circuit for performing light detection based automatic regulation of ON/OFF status of the LED lamp string, a circuit for timing control of selection of operation time period, a circuit for automatic regulation of lighting brightness.

The present invention further provides an LED lamp string device comprising an “N” quantity of LED lamp strings. The number N is greater than or equal to one (N≧1). The LED lamp strings are connected in parallel.

The efficacies of the present invention are as follows. Since the present invention adopts the above discussed technical features, the LED lamp string and the batteries are directly connected to allow for all-site and all-time operation of the lamp string without the need of installation of a power cable extending from an indoor alternate current power source, making the use safe and convenient for switching between different sites. Further, since the LED lamp string is controlled by a light controller so that the LED lamp string can be automatically turned on/off according to the surrounding being bright or dark, or the lighting brightness can be automatically regulated, or the lighting can be switched among various patterns of twinkling, leading to the advantages of labor saving, convenience, and practicability. Structurally, the light controller and the batteries are both enclosed in a hermetic, water-proof, and humidity-proof battery box and this greatly improves the safety of use and helps storage of the lamp string.

### BRIEF DESCRIPTION OF THE DRAWINGS

The present invention will be apparent to those skilled in the art by reading the following description of preferred embodiments thereof with reference to the drawings, in which:

FIG. 1 is a cross-sectional view of a battery box of a light-emitting diode (LED) lamp string device in accordance with the present invention;

FIG. 2 is a circuit diagram of the LED lamp string device in accordance with the present invention;

FIG. 3 is a circuit diagram of the LED lamp string device in accordance with another embodiment of the present invention;

FIG. 4 is a circuit diagram of the LED lamp string device in accordance with the present invention that is composed of N quantity of LED lamp strings; and

FIG. 5 is circuit block diagram of the LED lamp string device in accordance with the present invention.

### DETAILED DESCRIPTION OF THE PREFERRED EMBODIMENTS

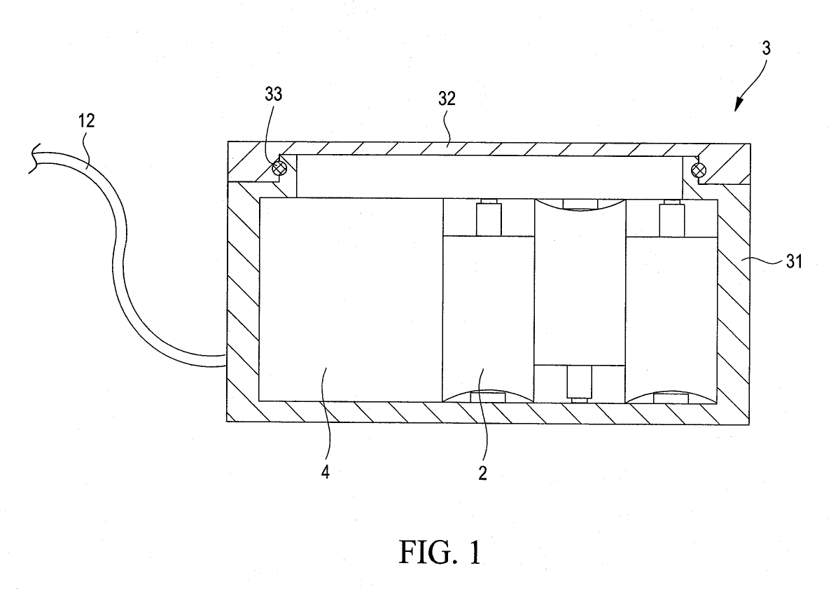

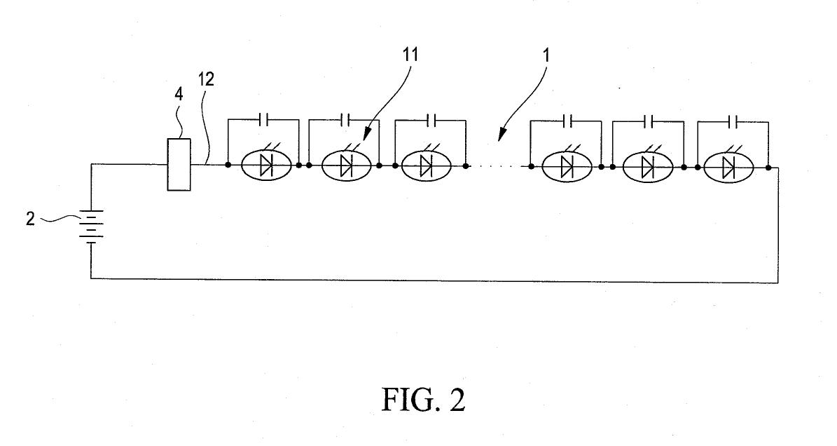

The present invention provides a light-emitting diode (LED) lamp string device with battery box. Reference is now made to FIGS. 1 and 2 for illustration of the present invention. The LED lamp string device of the present invention comprises a power supply system and a lamp string light emission system that are connected together. The lamp string light emission system comprises an LED lamp string 1 that is composed of a plurality of LED lamps 11 and electrical wires 12 that electrically connect the LED lamps 11 together. The power supply system comprises batteries 2 connected to the electrical wires 12 and also comprises a light controller 4 that are connected to both the LED lamp string 1 and batteries 2. The power supply system further comprises a battery box 3, and the light controller 4 and the batteries 2 are both received in the battery box 3 to prevent the direct current power source, the LED lamp string, and the light controller from tangling with each other and to facilitate movement between different sites.

Referring to FIG. 1, a preferred embodiment of the battery box 3 is illustrated. The battery box 3 comprises a box body 31 and a box cover 32 that are coupled to each other, and further comprises a sealing ring 33 that ensures tight engagement between the box body 31 and the box cover 32. The sealing ring 33 is received in a groove defined in the box cover 32. Thus, outdoor use of the LED lamp string is protected against poor weather and rains.

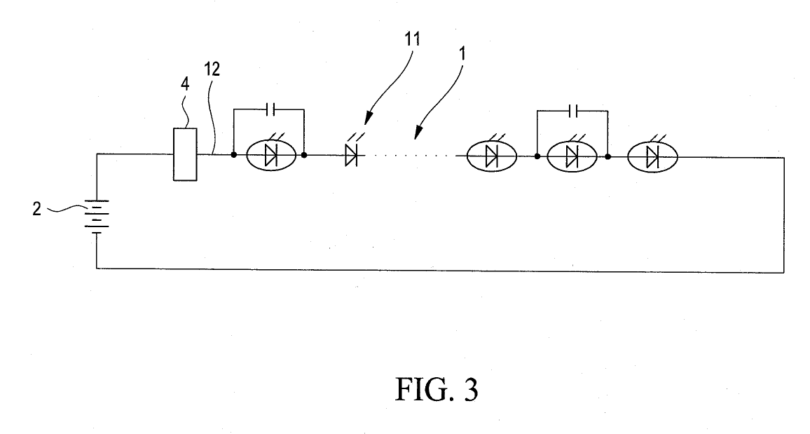

Referring to FIGS. 2, 3, and 5, preferred embodiments of the LED lamp string 1 are illustrated. The LED lamps 11 can be partially (refer to FIG. 3) or all (refer to FIG. 2) provided with the function of twinkling. The twinkling function is regulated and controlled by a light controller 4. The light controller 4 comprises a control circuit that comprises a control circuit that provides various pattern of lighting through controlling ON/OFF status of the twinkling function of the LED lamps 11.

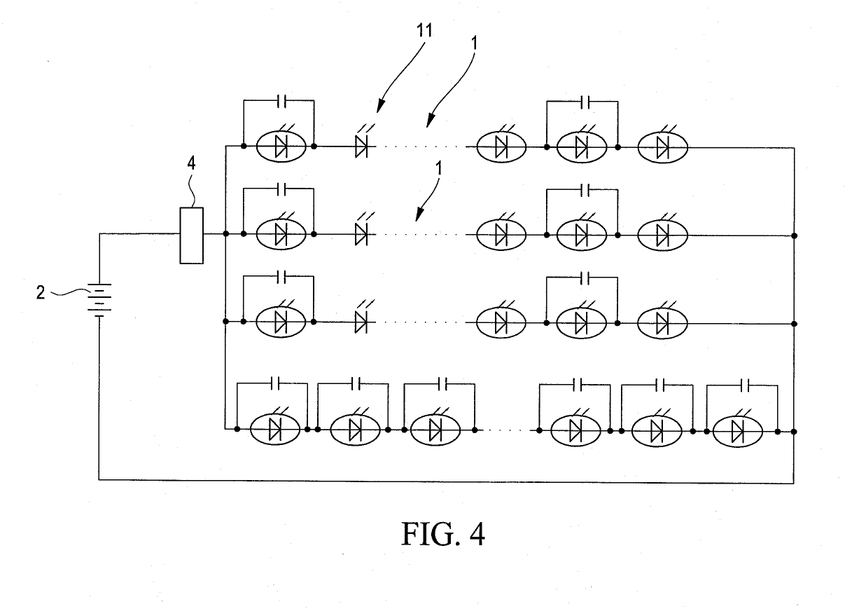

Referring to FIG. 4, another preferred embodiment of the LED lamp string 1 is illustrated, in which an “N” quantity of LED lamp strings 1 are included, where N is greater than or equal to one (N≧1), and the LED lamp strings 1 are connected in parallel.

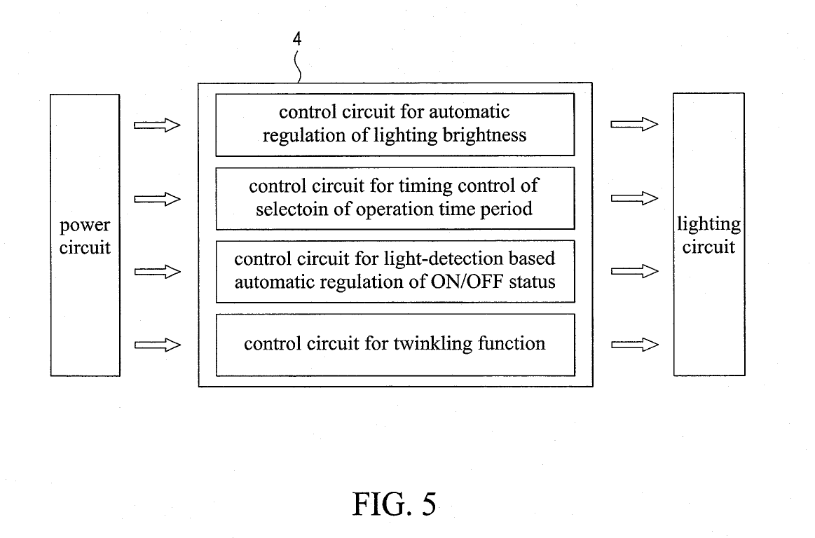

Referring to FIG. 5, a preferred embodiment of the light controller 4 is illustrated. The light controller 4 selectively, either individually or in combination, comprises a control circuit for light-detection based automatic regulation of ON/OFF status of the LED lamp string 1, a control circuit for timing control of selection of operation time period, and a control circuit for automatic regulation of lighting brightness, whereby the light controller 4 can automatically regulate the ON/OFF status of the LED lamp string 1 based on detection of light, actuate the LED lamp string 1 in a selected time period, automatically control lighting brightness, and switch into various patterns of lighting/twinkling to thereby realize automatic control, energy saving, power saving, high efficiency, and environmental protection. The circuit diagram shown in FIG. 5 includes a power circuit that comprises a circuit of the above mentioned power supply system mention, and the circuit diagram of FIG. 5 includes a lighting circuit that comprises a circuit of the lamp string light emission system.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lighting-emitting diode (LED) lamp string device, comprising a power supply system and a lamp string light emission system connected together, wherein:
the lamp string light emission system comprises an LED lamp string that comprises a plurality of LED lamps and electrical wires that electrically connect the LED lamps; and
the power supply system comprises batteries and a light controller that are connected to the LED lamp string through the electrical wires and further comprises a battery box, in which the light controller and the batteries are received.

2. lamp string device as claimed in claim 1, wherein the battery box comprises a box body and a box cover, and further comprises a sealing ring that is mounted to one of the box body and the box cover for providing tight engagement between the box body and the box cover.

3. The LED lamp string device as claimed in claim 1, wherein some of the LED lamps are provided with a function of twinkling.

4. The LED lamp string device as claimed in claim 1, wherein the LED lamps are all provided with a function of twinkling.

5. ED lamp string device as claimed in claim 3 or 4, wherein the light controller comprises a control circuit, which realizes various lighting patterns through controlling ON/OFF status of the twinkling function of the LED lamps.

6. The LED lamp string device as claimed in claim 5, wherein the control circuit of the light controller comprises a circuit for performing light detection based automatic regulation of ON/OFF status of the LED lamp string, a circuit for timing control of selection of operation time period, a circuit for automatic regulation of lighting brightness.

7. The LED lamp string device as claimed in claim 1, 2, 3, or 4, wherein the light controller comprises a control circuit, which comprises a circuit for performing light detection based automatic regulation of ON/OFF status of the LED lamp string, a circuit for timing control of selection of operation time period, a circuit for automatic regulation of lighting brightness.

8. The LED lamp string device as claimed in claim 1, 2, 3, or 4, comprising a quantity of LED lamp strings, the quantity being greater than or equal to one, the LED lamp strings being connected in parallel.
